(19) United States
(12) Patent Application Publication
(10) Pub. No.: US 2026/0126812 A1
(43) Pub. Date: May 7, 2026

(54) MANAGEMENT SYSTEM FOR UNMANNED VEHICLE AND MANAGEMENT METHOD FOR UNMANNED VEHICLE

(71) Applicant: KOMATSU LTD., Tokyo (JP)

(72) Inventors: Kenta SHINOHARA, Minato-ku, Tokyo (JP); Atsushi SAKAI, Minato-ku, Tokyo (JP); Misato MAEDA, Minato-ku, Tokyo (JP)

(73) Assignee: KOMATSU LTD., Tokyo (JP)

(21) Appl. No.: 19/116,354

(22) PCT Filed: Oct. 20, 2023
(86) PCT No.: PCT/JP2023/037979

§ 371 Date: Mar. 27, 2025

(30) Foreign Application Priority Data
Nov. 14, 2022 (JP) 2022-182115

(51) Int. Cl. G05D 1/65; G05D 105/05; G05D 107/70

(52) U.S. Cl. CPC G05D 1/65; G05D 2105/05; G05D 2107/73

(57) ABSTRACT

A management system for an unmanned vehicle includes: a traveling path generation unit, configured to generate a traveling path of an unmanned vehicle; a speed calculation unit, configured to calculate a target traveling speed of the unmanned vehicle traveling along the traveling path, based on the traveling path; and a detection unit, configured to detect a deceleration position indicating a position where the target traveling speed drops in the traveling path.

### TECHNICAL FIELD

The present disclosure relates to a management system for an unmanned vehicle and a management method for an unmanned vehicle.

### BACKGROUND ART

In a technical field related to unmanned vehicles, a management system for an unmanned vehicle including a transport device as disclosed in Patent Literature 1 is known.

### CITATION LIST

### Patent Literature

Patent Literature 1: JP 2021-174325A

### SUMMARY OF INVENTION

### Technical Problem

At a work site, an unmanned vehicle travels along a traveling path. If the traveling path has a part with a locally large curvature, the unmanned vehicle needs to decelerate in the part with the larger curvature. As the unmanned vehicle decelerates, productivity at the work site may decrease.

An object of the present disclosure is to suppress a decrease in productivity at the work site.

### Solution to Problem

According to the present disclosure, a management system for an unmanned vehicle is provided, the management system including: a traveling path generation unit, configured to generate a traveling path of an unmanned vehicle; a speed calculation unit, configured to calculate a target traveling speed of the unmanned vehicle traveling along the traveling path, based on the traveling path; and a detection unit, configured to detect a deceleration position indicating a position where the target traveling speed drops in the traveling path.

### Advantageous Effects of Invention

According to the present disclosure, a decrease in productivity at the work site is suppressed.

### BRIEF DESCRIPTION OF DRAWINGS

FIG. 1 is a schematic diagram illustrating a work site according to an embodiment.

FIG. 2 is a schematic diagram illustrating a management system for an unmanned vehicle according to the embodiment.

FIG. 3 is a block diagram illustrating the management system for the unmanned vehicle according to the embodiment.

FIG. 4 is a diagram showing the hardware configuration of a management device according to the embodiment.

FIG. 5 is a schematic diagram illustrating the traveling conditions of the unmanned vehicle according to the embodiment.

FIG. 6 is a diagram illustrating a method for generating a traveling path according to the embodiment.

FIG. 7 is a diagram illustrating a method for calculating a target traveling speed of the unmanned vehicle according to the embodiment.

FIG. 8 is a diagram illustrating upper limit speed data stored in a speed data storage unit according to the embodiment.

FIG. 9 is a diagram illustrating a speed profile displayed on a display device according to the embodiment.

FIG. 10 is a diagram illustrating an example of the traveling path according to the embodiment.

FIG. 11 is a diagram illustrating a speed profile and a deceleration position displayed on the display device according to the embodiment.

FIG. 12 is a diagram illustrating a traveling path and a deceleration position displayed on the display device according to the embodiment.

FIG. 13 is a diagram illustrating a management method for an unmanned vehicle according to the embodiment.

### DESCRIPTION OF EMBODIMENTS

Hereinafter, an embodiment according to the present disclosure will be described with reference to the drawings, but the present disclosure is not limited to the embodiment. The elements of the embodiment described below can be combined as appropriate. Also, in some cases, some elements are not used.

### Work Site

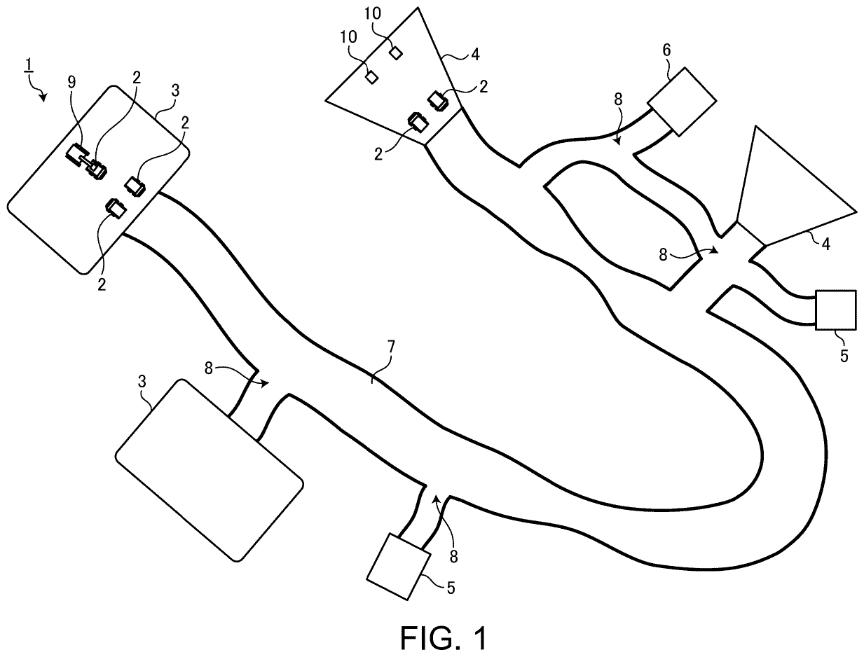

FIG. 1 is a schematic diagram illustrating a work site 1 according to the embodiment. Examples of the work site 1 include a mine or a quarry. The mine refers to a place or a place of business where minerals are mined. The quarry refers to a place or a place of business where stones are mined. Examples of the mine include a metal mine for mining metal, a non-metal mine for mining limestone, or a coal mine for mining coal.

At the work site 1, a plurality of unmanned vehicles 2 operate. The unmanned vehicle refers to a vehicle that operates in an unmanned state without depending on a driving operation by a driver. The unmanned vehicle 2 may be a work vehicle that performs predetermined work or may not be a work vehicle. In the embodiment, the unmanned vehicle 2 is a work vehicle traveling in an unmanned state in the work site 1. The unmanned vehicle 2 is a transport vehicle that performs transport work of transporting a load. In the embodiment, the unmanned vehicle 2 is referred to as an unmanned dump truck 2 as appropriate.

The work site 1 is provided with a loading area 3, a discharging area 4, a parking area 5, a fueling area 6, and a traveling track 7. A point of intersection 8 is provided at a part of the traveling track 7. The loading area 3 refers to an area where loading work of loading a load on the unmanned dump truck 2 is performed. Examples of the load include excavated material excavated in the loading area 3. In the loading area 3, a loader 9 operates. Examples of the loader 9 include a hydraulic shovel. The discharging area 4 refers to an area where discharging work of discharging a load from the unmanned dump truck 2 is performed. A crusher 10 is provided in the discharging area 4. The parking area 5 is an area where the unmanned dump truck 2 is parked. The fueling area 6 refers to an area where the unmanned dump truck 2 is fueled. The traveling track 7 refers to an area where the unmanned dump truck 2 travels. The traveling track 7 is provided so as to connect at least the loading area 3 and the discharging area 4. In the embodiment, the traveling track 7 is connected to each of the loading area 3, the discharging area 4, the parking area 5, and the fueling area 6. The point of intersection 8 refers to an area where a plurality of traveling tracks 7 intersect or an area where one traveling track 7 branches into a plurality of traveling tracks 7. The unmanned dump truck 2 can travel in each of the loading area 3, the discharging area 4, the parking area 5, the fueling area 6, and the traveling track 7. The unmanned dump truck 2 travels in the traveling track 7, for example, so as to move to and from the loading area 3 and the discharging area 4.

### Management System

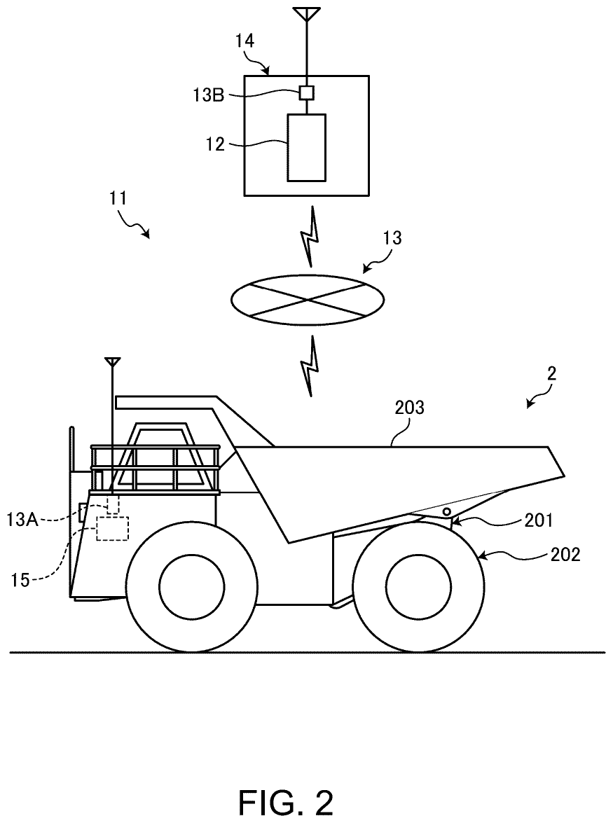

FIG. 2 is a schematic diagram illustrating a management system 11 for the unmanned vehicle 2 according to the embodiment. As shown in FIG. 2, the management system 11 includes a management device 12 and a communication system 13. The management device 12 is disposed outside the unmanned dump truck 2. The management device 12 is installed at a control facility 14 in the work site 1. The management device 12 includes a computer system. Examples of the communication system 13 include the internet, a mobile phone communication network, a satellite communication network, or a local area network (LAN).

The unmanned dump truck 2 includes a vehicle body 201, a traveling device 202, a dump body 203, a control device 15, and a wireless communication device 13A. The control device 15 includes a computer system. The wireless communication device 13A is connected to the control device 15.

The communication system 13 includes the wireless communication device 13A connected to the control device 15, and a wireless communication device 13B connected to the management device 12. The management device 12 and the control device 15 of the unmanned dump truck 2 wirelessly communicate with each other via the communication system 13.

The vehicle body 201 includes a vehicle body frame. The vehicle body 201 is supported by the traveling device 202. The traveling device 202 travels, supporting the vehicle body 201. The traveling device 202 includes a wheel, a tire mounted on the wheel, an engine, a brake device, and a steering device. The dump body 203 is a member on which a load is loaded. The dump body 203 is supported by the vehicle body 201. The dump body 203 performs a dumping operation and a lowering operation. The dumping operation refers to an operation of causing the dump body 203 to move away from the vehicle body 201 and incline in a dumping direction. The lowering operation refers to an operation of causing the dump body 203 to approach the vehicle body 201. In the case of performing the loading work, the dump body 203 performs the lowering operation. In the case of performing the discharging work, the dump body 203 performs the dumping operation.

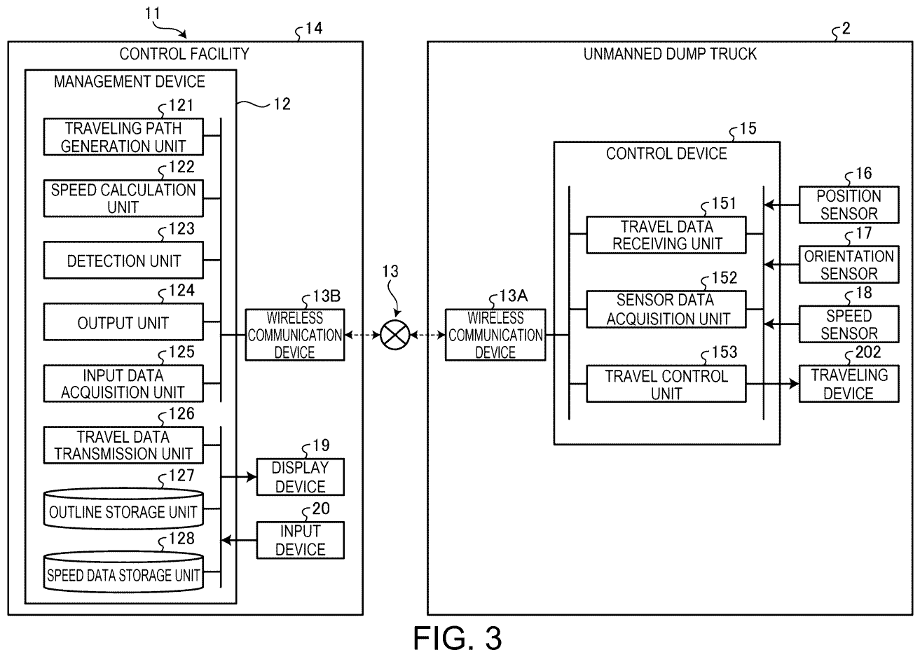

FIG. 3 is a block diagram illustrating the management system 11 for the unmanned vehicle 2 according to the embodiment. As illustrated in FIG. 3, the unmanned dump truck 2 includes the control device 15, the wireless communication device 13A, a position sensor 16, an orientation sensor 17, a speed sensor 18, and the traveling device 202. Each of the wireless communication device 13A, the position sensor 16, the orientation sensor 17, and the speed sensor 18 can communicate with the control device 15. The traveling device 202 is controlled by the control device 15.

The position sensor 16 detects the position of the unmanned dump truck 2. The position of the unmanned dump truck 2 is detected by using a global navigation satellite system (GNSS). The global navigation satellite system includes the global positioning system (GPS). The global navigation satellite system detects a position in a global coordinate system defined by coordinate data of latitude, longitude, and altitude. The global coordinate system refers to a coordinate system fixed to the earth. The position sensor 16 includes a GNSS receiver and detects an absolute position of the unmanned dump truck 2 indicating the position of the unmanned dump truck 2 in the global coordinate system.

The orientation sensor 17 detects the orientation of the unmanned dump truck 2. The orientation of the unmanned dump truck 2 includes the yaw angle of the unmanned dump truck 2. When an axis extending in the vertical direction at the center of gravity of the vehicle body 201 is defined as a yaw axis, the yaw angle refers to a rotation angle around the yaw axis. Examples of the orientation sensor 17 include a gyro sensor.

The speed sensor 18 detects the traveling speed of the unmanned dump truck 2. Examples of the speed sensor 18 include a pulse sensor that detects the rotation of the wheel of the unmanned dump truck 2.

A display device 19 and an input device 20 are connected to the management device 12. Each of the display device 19 and the input device 20 is arranged in the control facility 14. The display device 19 includes a display screen to display display data. Examples of the display device 19 include a flat panel display such as a liquid crystal display (LCD) or an organic electroluminescence display (OELD). The manager present at the control facility 14 can check the display data displayed on the display device 19. The display device 19 functions as an output device that outputs display data. The input device 20 is operated by the manager and thus generates input data. Examples of the input device 20 include a contact input device operated by a hand of the manager, such as a computer keyboard, a mouse, a touch panel, an operation switch, or an operation button. The input device 20 may be a voice input device operated in response to a voice of the manager. The input data generated by the input device 20 is output to the management device 12. The management device 12 acquires the input data from the input device 20.

The management device 12 includes a traveling path generation unit 121, a speed calculation unit 122, a detection unit 123, an output unit 124, an input data acquisition unit 125, a travel data transmission unit 126, an outline storage unit 127, and a speed data storage unit 128.

The traveling path generation unit 121 generates a traveling path 32 indicating the target traveling route of the unmanned dump truck 2. The unmanned dump truck 2 travels in the work site 1 in accordance with the traveling path 32. The speed calculation unit 122 calculates the target traveling speed of the unmanned dump truck 2, based on the traveling path 32 generated by the traveling path generation unit 121. The detection unit 123 detects a deceleration position 50 indicating a position where the target traveling speed of the unmanned dump truck 2 drops in the traveling path 32. The detection unit 123 detects a position where the target traveling speed becomes equal to or lower than a speed threshold, as the deceleration position 50. The speed threshold may be a predetermined value or may be specified by the input data from the input device 20. Also, the detection unit 123 may detect a position where the decrease rate of the target traveling speed is equal to or higher than a decrease rate threshold, as the deceleration position 50. The decrease rate of the target traveling speed refers to the amount of drop in the target traveling speed in relation to the travel distance of the unmanned dump truck 2. That is, the decrease rate of the target traveling speed is a differential value of the target traveling speed that drops. The decrease rate threshold may be a predetermined value or may be specified by the input data from the input device 20.

The output unit 124 controls the display device 19. The output unit 124 causes the display device 19 to display the display data. The input data acquisition unit 125 acquires the input data from the input device 20. The travel data transmission unit 126 transmits travel data indicating the traveling conditions of the unmanned dump truck 2 to the unmanned dump truck 2. The travel data of the unmanned dump truck 2 includes the traveling path 32 generated by the traveling path generation unit 121 and the target traveling speed calculated by the speed calculation unit 122. The travel data transmission unit 126 transmits the travel data of the unmanned dump truck 2 to the control device 15 of the unmanned dump truck 2 via the communication system 13.

The control device 15 includes a travel data receiving unit 151, a sensor data acquisition unit 152, and a travel control unit 153. The travel data receiving unit 151 acquires the travel data of the unmanned dump truck 2 transmitted from the travel data transmission unit 126, from the management device 12 via the communication system 13. The sensor data acquisition unit 152 acquires detection data of the position sensor 16, detection data of the orientation sensor 17, and detection data of the speed sensor 18. The travel control unit 153 controls the traveling device 202, based on the traveling conditions of the unmanned dump truck 2 acquired by the travel data receiving unit 151 and the detection data acquired by the sensor data acquisition unit 152.

### Computer System

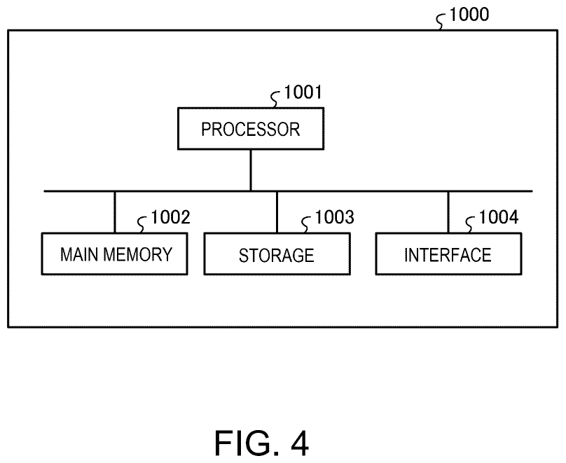

FIG. 4 is a diagram showing the hardware configuration of the management device 12 according to the embodiment. The management device 12 includes a computer system 1000. The computer system 1000 includes a processor 1001 such as a central processing unit (CPU), a main memory 1002 including a nonvolatile memory such as a read-only memory (ROM) and a volatile memory such as a random-access memory (RAM), a storage 1003, and an interface 1004 including an input/output circuit. The above functions of the management device 12 are stored as a computer program in the storage 1003. The processor 1001 reads out the computer program from the storage 1003, loads the computer program into the main memory 1002, and executes the above processing in accordance with the program. Note that the computer program may be distributed to the computer system 1000 via a network. Each of the control devices 15, too, includes the computer system 1000 as shown in FIG. 4. The above functions of the control device 15 are stored as a computer program in the storage 1003.

### Traveling Conditions

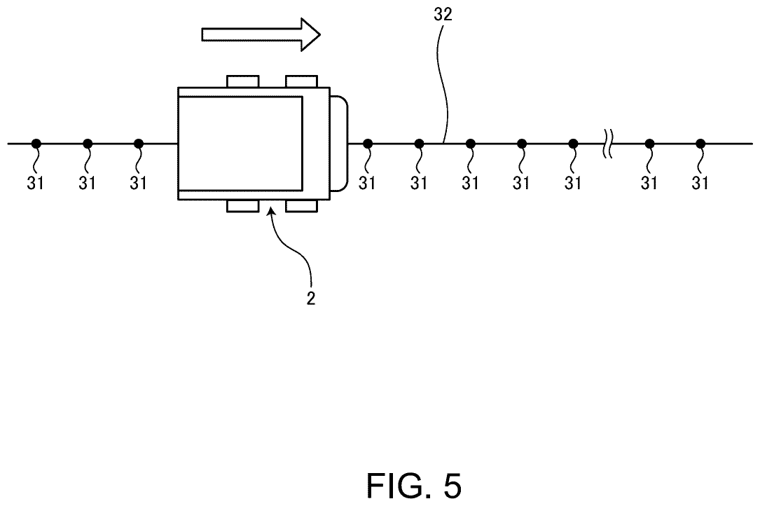

FIG. 5 is a schematic diagram illustrating the traveling conditions of the unmanned dump truck 2 according to the embodiment. The travel data indicating the traveling conditions of the unmanned dump truck 2 includes a traveling point 31, the traveling path 32, a target position of the unmanned dump truck 2, a target orientation of the unmanned dump truck 2, and a target traveling speed of the unmanned dump truck 2.

A plurality of traveling points 31 are set in the work site 1. The traveling point 31 defines the target position of the unmanned dump truck 2. The target orientation of the unmanned dump truck 2 and the target traveling speed of the unmanned dump truck 2 are set for each of the plurality of traveling points 31. The plurality of traveling points 31 are set, spaced apart from each other. The interval between the traveling points 31 is 1 m or longer and 5 m or shorter. The interval between the traveling points 31 may be uniform or non-uniform. In the embodiment, the traveling points 31 are set at an interval of 1 m.

The traveling path 32 refers to an imaginary line indicating the target traveling route of the unmanned dump truck 2. The traveling path 32 is defined by a trajectory of passage through the plurality of traveling points 31. The unmanned dump truck 2 travels in the work site 1 in accordance with the traveling path 32. The unmanned dump truck 2 travels such that the center of the unmanned dump truck 2 and the traveling path 32 coincide with each other in the vehicle width direction of the unmanned dump truck 2.

The target position of the unmanned dump truck 2 refers to the target position of the unmanned dump truck 2 when passing through the traveling point 31. The target position of the unmanned dump truck 2 may be defined in a local coordinate system of the unmanned dump truck 2 or may be defined in a global coordinate system. The target orientation of the unmanned dump truck 2 refers to the target orientation of the unmanned dump truck 2 when passing through the traveling point 31. The target traveling speed of the unmanned dump truck 2 refers to the target traveling speed of the unmanned dump truck 2 when passing through the traveling point 31.

The travel control unit 153 controls the traveling device 202 such that the unmanned dump truck 2 travels along the traveling path 32, based on the travel data of the unmanned dump truck 2 and the detection data acquired from the sensor data acquisition unit 152. The travel control unit 153 controls the traveling device 202 such that the deviation between the detected position of the unmanned dump truck 2 detected by the position sensor 16 when passing through the traveling point 31 and the target position of the unmanned dump truck 2 set for the traveling point 31 decreases. The travel control unit 153 controls the traveling device 202 such that the deviation between the detected orientation of the unmanned dump truck 2 detected by the orientation sensor 17 when passing through the traveling point 31 and the target orientation of the unmanned dump truck 2 set for the traveling point 31 decreases. The travel control unit 153 controls the traveling device 202 such that the deviation between the detected traveling speed of the unmanned dump truck 2 detected by the speed sensor 18 when passing through the traveling point 31 and the target traveling speed of the unmanned dump truck 2 set for the traveling point 31 decreases.

### Generation of Traveling Path

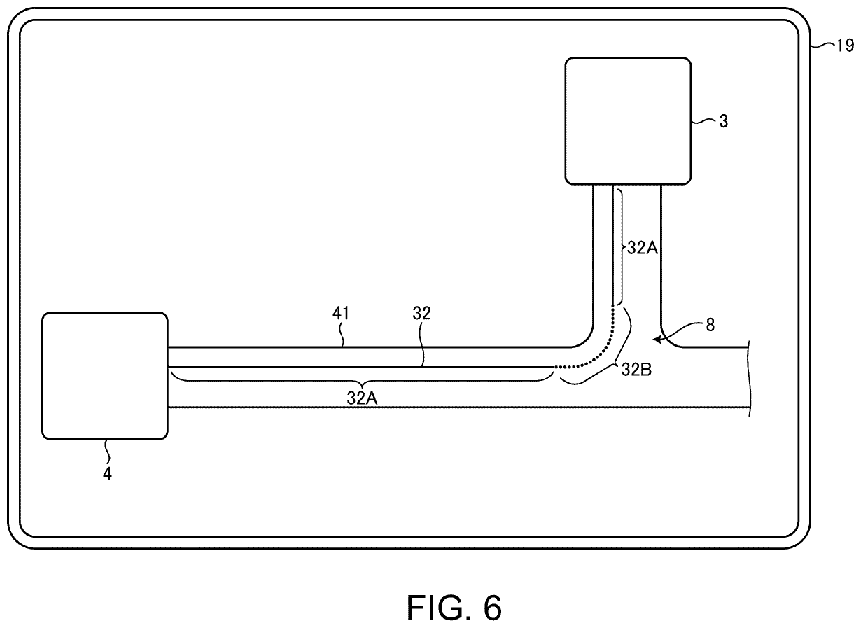

FIG. 6 is a diagram illustrating a method for generating the traveling path 32 according to the embodiment. The traveling path generation unit 121 generates the traveling path 32 so as to connect the departure position and the arrival position of the unmanned dump truck 2. The unmanned dump truck 2 travels between the loading area 3 and the discharging area 4. The unmanned dump truck 2 travels in the traveling track 7, for example, so as to move to and from the loading area 3 and the discharging area 4. In the embodiment, the departure position of the unmanned dump truck 2 is set to be the loading area 3, and the arrival position of the unmanned dump truck 2 is set to be the discharging area 4. Note that the departure position of the unmanned dump truck 2 may be set to be discharging area 4 and that the arrival position of the unmanned dump truck 2 may be set to be the loading area 3. The traveling path generation unit 121 generates the traveling path 32 in the traveling track 7 so as to connect the loading area 3 and the discharging area 4.

When generating the traveling path 32 in the traveling track 7, the traveling path generation unit 121 generates the traveling path 32, based on an outline 41 of the traveling track 7. The outline 41 of the traveling track 7 refers to an edge line of the traveling track 7 in which the unmanned dump truck 2 is permitted to travel. The outline 41 of the traveling track 7 can be regarded as a division line that defines a permission area where the unmanned dump truck 2 is permitted to travel and a prohibition area outside the traveling track 7 where the traveling is prohibited.

Outline data indicating the outline 41 of the traveling track 7, where the unmanned dump truck 2 travels, is derived in advance and stored in the outline storage unit 127. In the embodiment, the outline 41 is derived from the result of a survey of the topography of the work site 1. Also, the outline 41 may be derived, for example, from design data of the work site 1. The outline 41 may be derived from detection data of a GNSS receiver installed on a measurement vehicle traveling along the outline 41. The outline 41 may be derived from measurement data of a three-dimensional measurement device installed on a flying object flying along the outline 41. Examples of the flying object include a drone. Examples of the three-dimensional measurement device include a stereo camera or a laser range finder. The outline 41 may be derived from an aerial photograph of the work site 1.

The traveling path generation unit 121 automatically generates the traveling path 32, based on the outline 41. As illustrated in FIG. 6, the traveling path generation unit 121 generates the traveling path 32, for example, at a position shifted from the outline 41 toward the center of the traveling track 7 by a predetermined amount in the width direction of the traveling track 7.

The traveling path generation unit 121 can generate at least a part of the traveling path 32, based on the input data from the input device 20. In the embodiment, when generating the traveling path 32 at the point of intersection 8, the traveling path generation unit 121 generates the traveling path 32 at the point of intersection 8 where the unmanned dump truck 2 travels, based on the input data from the input device 20. The manager present at the control facility 14 can operate the input device 20 to generate the traveling path 32 at the point of intersection 8 while checking the traveling track 7 and the point of intersection 8 displayed on the display device 19. For example, as illustrated in FIG. 6, the traveling path generation unit 121 generates a traveling path 32A at a non-intersection part of the traveling track 7, based on the outline 41. The manager operates the input device 20 so as to connect a pair of traveling paths 32A generated at the non-intersection part while checking the traveling paths 32A displayed on the display device 19. The traveling path generation unit 121 generates a traveling path 32B at the point of intersection 8 so as to connect the pair of traveling paths 32A, based on the input data from the input device 20.

### Calculation of Target Speed

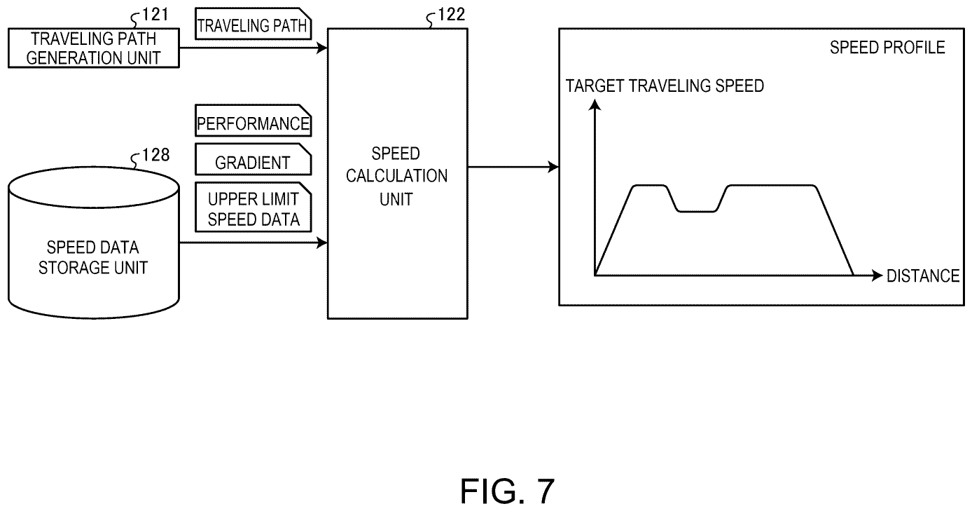

FIG. 7 is a diagram illustrating a method for calculating the target traveling speed of the unmanned dump truck 2 according to the embodiment. The speed calculation unit 122 calculates the target traveling speed of the unmanned dump truck 2, based on the traveling path 32 generated by the traveling path generation unit 121. If the curvature of the traveling path 32 is large, the target traveling speed is set to a low value so that the unmanned dump truck 2 traveling along the traveling path 32 does not deviate from the traveling path 32. If the curvature of the traveling path 32 is small, the target traveling speed is set to a high value so that the unmanned dump truck 2 travels at a high speed along the traveling path 32. Since the unmanned dump truck 2 travels at a high speed, a decrease in productivity at the work site 1 is suppressed.

In the embodiment, the speed calculation unit 122 calculates the target traveling speed of the unmanned dump truck 2, based on the traveling path 32 and stored data stored in the speed data storage unit 128. The stored data stored in the speed data storage unit 128 is known data used to calculate the target traveling speed, and is stored in advance in the speed data storage unit 128. Examples of the known data stored in the speed data storage unit 128 include the traveling performance of the unmanned dump truck 2, the gradient of the traveling track 7, and the curvature (shape) of the curve of the traveling track 7. The traveling performance of the unmanned dump truck 2 includes the maximum value of the traveling speed of the unmanned dump truck 2, the maximum value of acceleration, and the brake performance. The traveling performance of the unmanned dump truck 2 is known data that can be derived from specification data of the unmanned dump truck 2. In the embodiment, the gradient of the traveling track 7 is derived from the result of a survey of the topography of the work site 1. The gradient of the traveling track 7 may be derived from measurement data of a three-dimensional measurement apparatus installed on a flying object flying along the outline 41.

Also, examples of the known data stored in the speed data storage unit 128 include upper limit speed data indicating the relationship between the gradient of the traveling track 7 where the unmanned dump truck 2 travels and the upper limit value of the traveling speed of the unmanned dump truck 2. The speed calculation unit 122 may calculate the target traveling speed, based on the gradient of the traveling track 7 derived from the result of the survey and the upper limit speed data. Also, examples of the known data stored in the speed data storage unit 128 include a speed limit area indicating the relationship between an area with a speed limit and the speed limit, or a traveling path shape indicating the shape of the traveling path. The speed calculation unit 122 may calculate the target traveling speed, using the speed limit area or the traveling path shape.

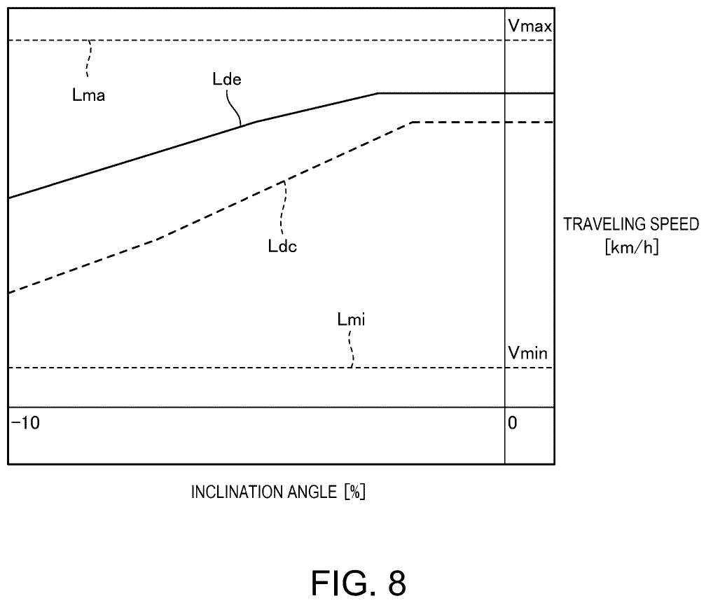

FIG. 8 is a diagram illustrating the upper limit speed data stored in the speed data storage unit 128 according to the embodiment. In the graph shown in FIG. 8, the vertical axis represents the upper limit value of the traveling speed of the unmanned dump truck 2, and the horizontal axis represents the inclination angle of the downhill of the traveling track 7. Also, in the example shown in FIG. 8, the inclination angle is expressed in [%] and the traveling speed is expressed in [km/h]. For example, the inclination angle of a descent of 10 m in an advance of 100 m in the horizontal direction is −10%.

In the embodiment, two types of upper limit speed data indicating the relationship between the inclination angle of the downhill and the upper limit value of the traveling speed are stored in the speed data storage unit 128. In FIG. 8, a line Lde indicates the upper limit speed data of an unloaded state, and a line Ldc indicates the upper limit speed data of a loaded state. The unloaded state refers to a state where no load is loaded on the dump body 203. The loaded state refers to a state where a load is loaded on the dump body 203. As indicated by the line Lde and the line Ldc, the upper limit speed data of the unloaded state is higher than the upper limit speed data of the loaded state at a certain inclination angle. That is, the unmanned dump truck 2 in the unloaded state is allowed to travel at a higher speed than the unmanned dump truck 2 in the loaded state. When the unmanned dump truck 2 in the unloaded state and the unmanned dump truck 2 in the loaded state travel under the same conditions and are braked under the same conditions, the braking distance of the unmanned dump truck 2 in the unloaded state is shorter than the braking distance of the unmanned dump truck 2 in the loaded state. Thus, the unmanned dump truck 2 in the unloaded state is allowed to travel at a higher speed than the unmanned dump truck 2 in the loaded state. Also, as the inclination angle of the downhill becomes larger, the upper limit of the traveling speed of the unmanned dump truck 2 becomes lower. That is, the upper limit value of the traveling speed of the unmanned dump truck 2 is set such that the unmanned dump truck 2 travels at a lower speed as the gradient of the downhill becomes steeper.

The upper limit of the traveling speed is determined, for example, based on the brake performance of the unmanned dump truck 2. As shown in FIG. 8, in the embodiment, a maximum value Vmax of the traveling speed indicated by a line Lma and a minimum value Vmin of the traveling speed indicated by a line Lmi are defined. The maximum value Vmax of the traveling speed is a value equal to or higher than the upper limit value of the traveling speed. The minimum value Vmin of the traveling speed is a value larger than zero. The speed calculation unit 122 calculates the target traveling speed for each of the plurality of traveling points 31, based on the gradient of the traveling track 7 and the upper limit speed data between the maximum value Vmax and the minimum value Vmin.

As illustrated in FIG. 7, the speed calculation unit 122 calculates a speed profile indicating the relationship between the distance from the loading area 3, which is the departure position in the traveling path 32, and the target traveling speed. In the embodiment, the speed calculation unit 122 calculates the speed profile in the traveling path 32 that has been generated so as to connect the loading area 3 and the discharging area 4. That is, the speed calculation unit 122 calculates the target traveling speed for each of the plurality of traveling points 31 set between the loading area 3 and the discharging area 4.

### Display of Speed Profile

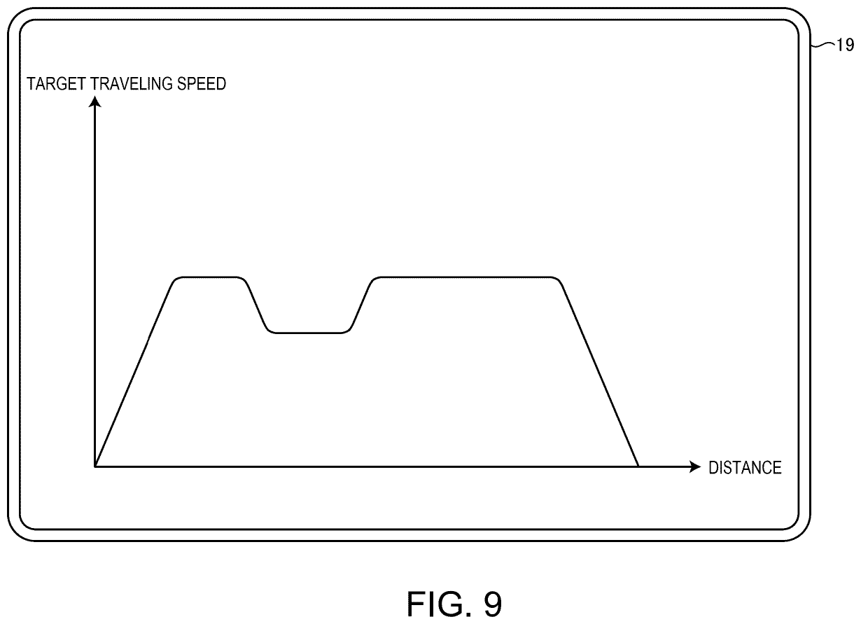

FIG. 9 is a diagram illustrating the speed profile displayed on the display device 19 according to the embodiment. The output unit 124 outputs the speed profile calculated by the speed calculation unit 122. The output unit 124 causes the display device 19 to display the speed profile calculated by the speed calculation unit 122. The manager checks the speed profile displayed on the display device 19 and thus can check the traveling condition of the unmanned dump truck 2.

### Detection of Deceleration Position

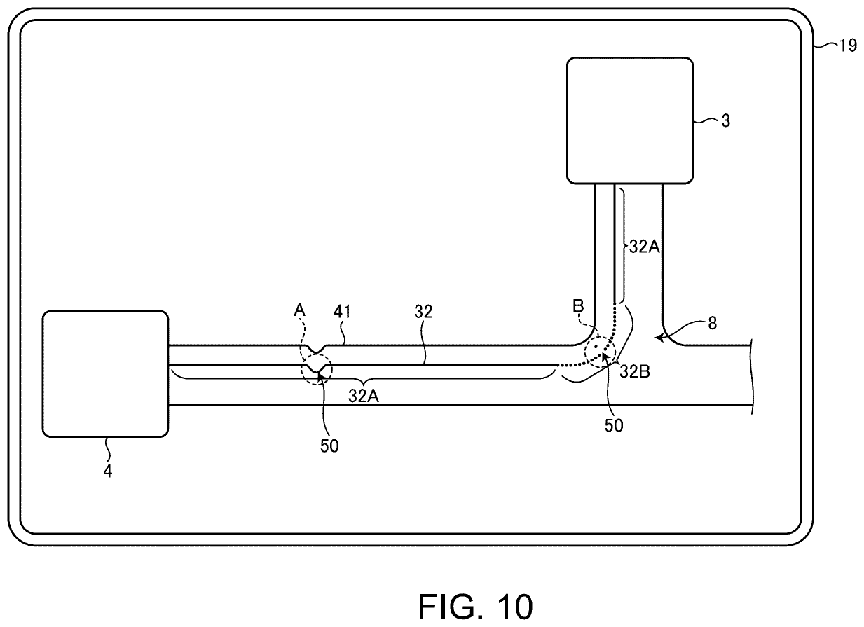

FIG. 10 is a diagram illustrating an example of the traveling path 32 according to the embodiment. As illustrated in FIG. 10, for example, a part B having a locally large curvature may be formed in the traveling path 32B due to an operation error of the input device 20 by the manager. Also, if there is a part locally having a large curvature in a part of the outline 41, a part A having a locally large curvature may be formed in the traveling path 32A in accordance with the curvature of the outline 41. As described above, the speed calculation unit 122 sets the target traveling speed to a high value when the curvature of the traveling path 32 is small, and sets the target traveling speed to a low value when the curvature of the traveling path 32 is large.

In the embodiment, the detection unit 123 detects the deceleration position 50 indicating a position where the target traveling speed locally drops in the traveling path 32. The detection unit 123 detects the deceleration position 50 in the speed profile between the loading area 3 and the discharging area 4. In the example illustrated in FIG. 10, each of the part B of the traveling path 32B and the part A of the traveling path 32A is the deceleration position 50. When the deceleration position 50 is detected by the detection unit 123, the output unit 124 outputs the speed profile and the deceleration position 50 in the speed profile. The output unit 124 causes the display device 19 to display the speed profile and the deceleration position 50.

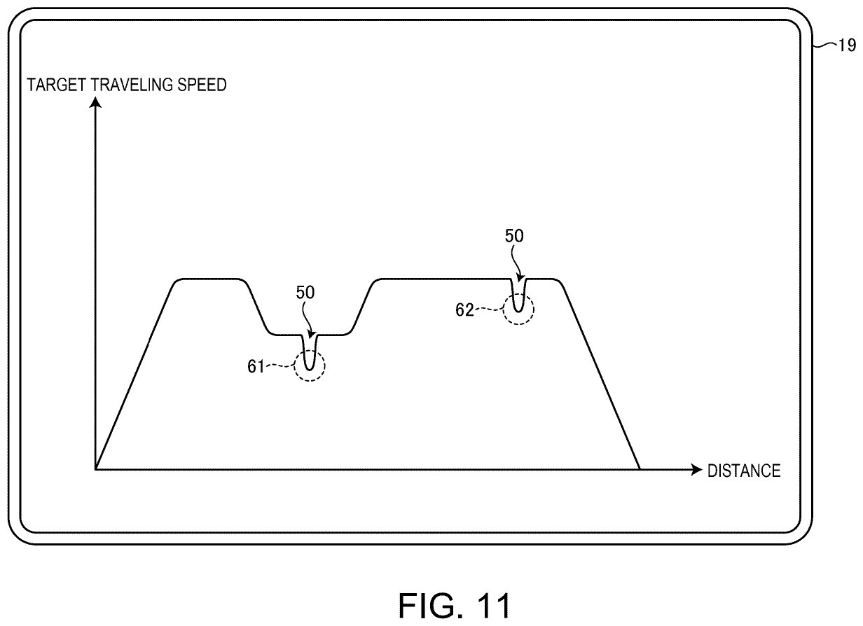

FIG. 11 is a diagram illustrating the speed profile and the deceleration position 50 displayed on the display device 19 according to the embodiment. As shown in FIG. 11, the target traveling speed drops locally at the deceleration position 50. The deceleration position 50 is displayed as a site where the target speed locally drops in the speed profile. The manager checks the speed profile displayed on the display device 19 and thus can recognize that the deceleration position 50 is generated.

The output unit 124 causes the display device 19 to display the deceleration position 50 in a different display form from the other positions in the speed profile. The output unit 124 highlights the deceleration position 50 in the speed profile so that the deceleration position 50 is emphasized as compared with the other positions in the speed profile. In the example illustrated in FIG. 11, a circular symbol 61 is displayed as superimposed on the deceleration position 50 in the traveling path 32B, and a circular symbol 62 is displayed as superimposed on the deceleration position 50 in the traveling path 32A. Note that the method for highlighting the deceleration position 50 as compared with the other positions in the speed profile is not limited to the symbol, and for example, the deceleration position 50 may be displayed in a different color from the other positions.

The manager can operate the input device 20 to designate the deceleration position 50 in the speed profile displayed on the display device 19. For example, the manager can operate the input device 20 such that a pointer displayed on the display device 19 and the deceleration position 50 overlap each other. The pointer can be moved on the display screen of the display device 19, based on the input data from the input device 20. When the input device 20 is a mouse, for example, the manager clicks a button on the mouse after operating the mouse such that the pointer and the deceleration position 50 overlap each other. As the button on the mouse is clicked, designation data designating the deceleration position 50 displayed on the display device 19 is generated as the input data. The output unit 124 causes the display device 19 to display the traveling path 32 and the deceleration position 50 in the traveling path 32, based on the designation data.

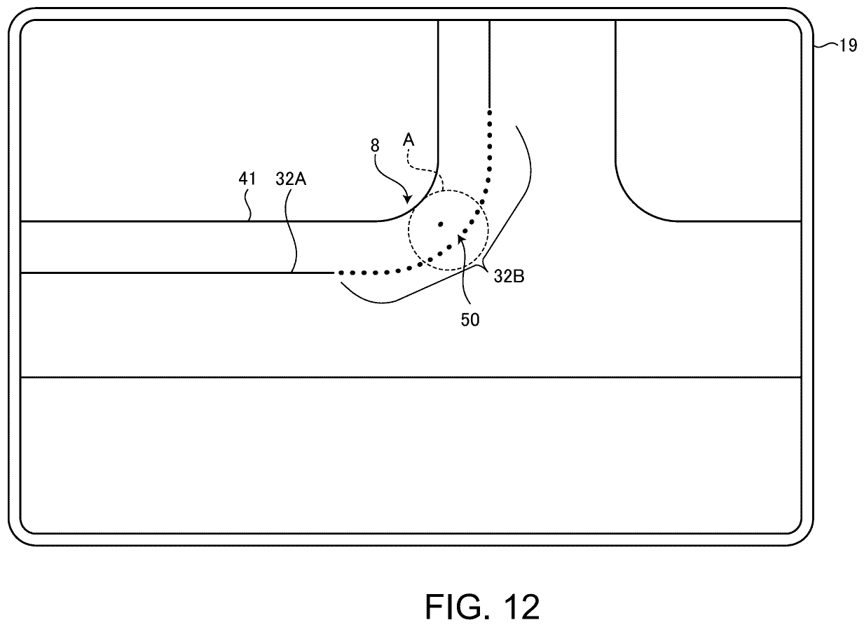

FIG. 12 is a diagram illustrating the traveling path 32 and the deceleration position 50 displayed on the display device 19 according to the embodiment. As the button on the mouse is clicked after the mouse is operated such that, for example, the deceleration position 50 with the symbol 61 superimposed thereon overlaps the pointer on the display screen of the display device 19 illustrated in FIG. 11, the traveling path 32B and the deceleration position 50 in the traveling path 32B are displayed in an enlarged form on the display device 19, as illustrated in FIG. 12. The manager checks the display device 19 and thus can recognize that there is an operation error of the input device 20 in the generation of the traveling path 32B. The manager can operate the input device 20 to correct the traveling path 32B so that the traveling path 32B becomes smooth, while checking the display device 19 illustrated in FIG. 12. The input data generated by the operation of the input device 20 includes correction data to correct the traveling path 32B. The traveling path generation unit 121 corrects the traveling path 32B, based on the correction data.

### Management Method

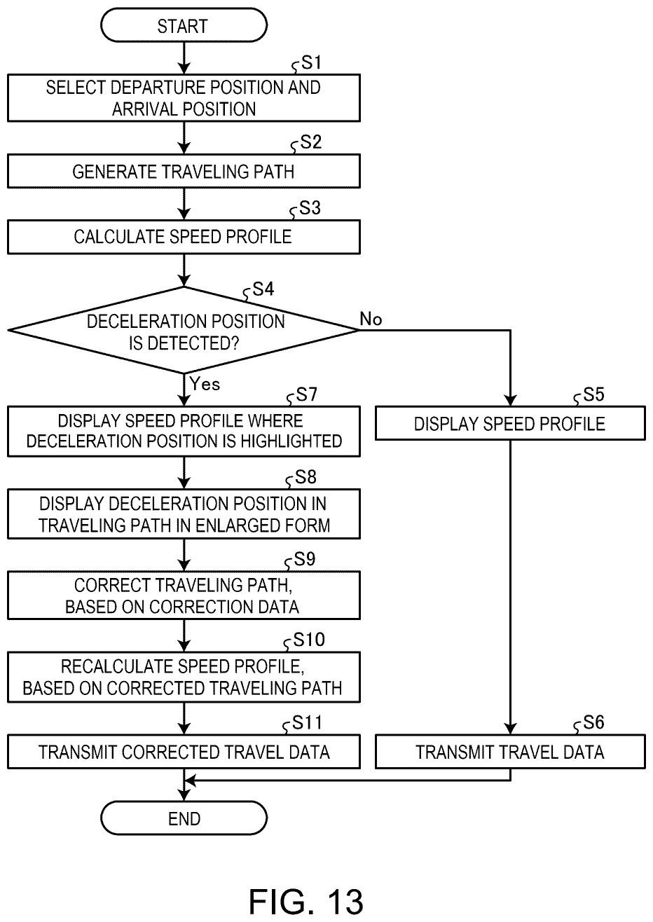

FIG. 13 is a diagram illustrating a management method for the unmanned vehicle according to the embodiment. The manager operates the input device 20 to select the departure position and the arrival position of the unmanned dump truck 2 in the work site 1. The input data acquisition unit 125 acquires input data indicating the departure position and the arrival position selected by the manager (step S1).

The traveling path generation unit 121 generates the traveling path 32 so as to connect the departure position and the arrival position specified in step S1. As described above, the traveling path generation unit 121 generates the traveling path 32A in the non-intersection part of the traveling track 7, based on the outline data stored in the outline storage unit 127. The traveling path generation unit 121 generates the traveling path 32B at the point of intersection 8 in the traveling track 7, based on the input data acquired by the input data acquisition unit 125 (step S2).

The speed calculation unit 122 calculates the target traveling speed of the unmanned dump truck 2 traveling along the traveling path 32, based on the traveling path 32 generated in step S2. The speed calculation unit 122 calculates the speed profile in the traveling path 32 connecting the departure position and the arrival position (step S3).

The detection unit 123 detects the deceleration position 50 indicating the position where the target traveling speed drops in the traveling path 32 (step S4). When the deceleration position 50 is not detected in step S4 (No in step S4), the output unit 124 causes the display device 19 to display the speed profile calculated in step S3 (step S5). On the display device 19, the speed profile that does not include the deceleration position 50 as shown in FIG. 9 is displayed. The travel data transmission unit 126 transmits travel data including the traveling path 32 generated in step S2 and the speed profile of the unmanned dump truck 2 calculated in step S3 to the unmanned dump truck 2 (step S6). The unmanned dump truck 2 travels in the work site 1, based on the travel data transmitted from the management device 12.

When the deceleration position 50 is detected in step S4 (Yes in step S4), the output unit 124 causes the display device 19 to display the speed profile in which the deceleration position 50 is highlighted (step S7). On the display device 19, the speed profile including the deceleration position 50 as shown in FIG. 11 is displayed.

The manager can operate the input device 20 to designate the deceleration position 50 in the speed profile displayed on the display device 19. When the input device 20 is a mouse, for example, the manager clicks a button on the mouse after operating the mouse such that the pointer and the deceleration position 50 overlap each other. As the button on the mouse is clicked, designation data designating the deceleration position 50 displayed on the display device 19 is generated as the input data. The output unit 124 causes the display device 19 to display the deceleration position 50 in the traveling path 32 in an enlarged form, based on the designation data acquired by the input data acquisition unit 125 (step S8). As shown in FIG. 12, on the display device 19, the deceleration position 50 in the traveling path 32 is displayed in an enlarged form.

The manager can operate the input device 20 to correct the traveling path 32 such that the traveling path 32 in the deceleration position 50 becomes, for example, a straight line, while checking the display device 19. The input data generated by the operation of the input device 20 includes correction data to correct the traveling path 32. The traveling path generation unit 121 corrects the traveling path 32, based on the correction data acquired by the input data acquisition unit 125 (step S9).

The speed calculation unit 122 recalculates the target traveling speed of the unmanned dump truck 2, based on the corrected traveling path indicating the traveling path corrected based on the correction data. The speed calculation unit 122 recalculates the speed profile in the traveling path 32 connecting the departure position and the arrival position, based on the corrected traveling path (step S10).

The travel data transmission unit 126 transmits corrected travel data including the corrected traveling path generated in step S9 and the speed profile of the unmanned dump truck 2 recalculated in step S10, to the unmanned dump truck 2 (step S11). The unmanned dump truck 2 travels in the work site 1, based on the corrected travel data transmitted from the management device 12.

### Effects

As described above, in the embodiment, the management system 11 for the unmanned dump truck 2 includes: the traveling path generation unit 121, which generates the traveling path 32 of the unmanned dump truck 2; the speed calculation unit 122, which calculates the target traveling speed of the unmanned dump truck 2 traveling along the traveling path 32, based on the traveling path 32; and the detection unit 123, which detects the deceleration position 50 indicating the position where the target traveling speed drops in the traveling path 32. As the deceleration position 50 is detected, the management device 12 can cause the display device 19 to display the deceleration position 50. That is, the deceleration position 50 is visualized. As the deceleration position 50 is visualized, the manager can correct the traveling path 32 such that the deceleration position 50 disappears. Since the deceleration position 50 disappears, unnecessary deceleration of the unmanned dump truck 2 traveling in the work site 1 is suppressed. Since unnecessary deceleration of the unmanned dump truck 2 is suppressed, a decrease in productivity at the work site 1 is suppressed.

### Other Embodiments

In the above embodiment, at least a part of the functions of the control device 15 may be provided in the management device 12, or at least a part of the functions of the management device 12 may be provided in the control device 15.

In the above embodiment, the output unit 124 may not cause the display device 19 to display the deceleration position 50 in a different display form from the other positions in the speed profile. The output unit 124 may cause the display device 19 to display the speed profile and the deceleration position 50, and may not cause the display device 19 to display the deceleration position 50 in a different display form from the other positions. The manager can recognize the deceleration position 50, based on the speed profile and the deceleration position 50 displayed on the display device 19.

In the above embodiment, a plurality of functions of the management device 12 may be configured with separate pieces of hardware. That is, each of the traveling path generation unit 121, the speed calculation unit 122, the detection unit 123, the output unit 124, the input data acquisition unit 125, the travel data transmission unit 126, the outline storage unit 127, and the speed data storage unit 128 may be configured with separate pieces of hardware. Similarly, a plurality of functions of the control device 15 may be configured with separate pieces of hardware.

### REFERENCE SIGNS LIST

1: work site
2: unmanned dump truck (unmanned vehicle)
3: loading area
4: discharging area
5: parking area
6: fueling area
7: traveling track
8: point of intersection
9: loader
10: crusher
11: management system
12: management device
13: communication system
13A: wireless communication device
13B: wireless communication device
14: control facility
15: control device
16: position sensor
17: orientation sensor
18: speed sensor
19: display device
20: input device
31: traveling point
32: traveling path
32A: traveling path
32B: traveling path
41: outline
50: deceleration position
61: symbol
62: symbol
121: traveling path generation unit
122: speed calculation unit
123: detection unit
124: output unit
125: input data acquisition unit
126: travel data transmission unit
127: outline storage unit
128: speed data storage unit
151: travel data receiving unit
152: sensor data acquisition unit
153: travel control unit
201: vehicle body
202: traveling device
203: dump body
1000: computer system
1001: processor
1002: main memory
1003: storage
1004: interface

1. A management system for an unmanned vehicle, comprising:
a traveling path generation unit, configured to generate a traveling path of an unmanned vehicle;
a speed calculation unit, configured to calculate a target traveling speed of the unmanned vehicle traveling along the traveling path, based on the traveling path; and
a detection unit, configured to detect a deceleration position indicating a position where the target traveling speed drops in the traveling path.

2. The management system for an unmanned vehicle according to claim 1, wherein
the detection unit is configured to detect a position where the target traveling speed becomes equal to or lower than a speed threshold, as the deceleration position.

3. The management system of an unmanned vehicle according to claim 1, wherein
the traveling path generation unit is configured to generate the traveling path so as to connect a departure position and an arrival position of the unmanned vehicle,
the speed calculation unit is configured to calculate a speed profile indicating a relationship between a distance from the departure position in the traveling path and the target traveling speed, and
the detection unit is configured to detect the deceleration position in the speed profile.

4. The management system of an unmanned vehicle according to claim 3, wherein
the unmanned vehicle is an unmanned dump truck traveling between a loading area and a discharging area,
the departure position is defined to be one of the loading area and the discharging area, and
the arrival position is defined to be the other of the loading area and the discharging area.

5. The management system for an unmanned vehicle according to claim 3, further comprising:
an output unit, configured to output the speed profile and the deceleration position in the speed profile.

6. The management system for an unmanned vehicle according to claim 5, wherein
the output unit is configured to cause a display device to display the speed profile and the deceleration position.

7. The management system of an unmanned vehicle according to claim 6, wherein
the output unit is configured to cause the display device to display the deceleration position in a different display form from other positions in the speed profile.

8. The management system of an unmanned vehicle according to claim 7, further comprising:
an input data acquisition unit, configured to acquire an input data from an input device,
wherein
the input data includes a designation data indicating the deceleration position displayed on the display device, and
the output unit is configured to cause the display device to display the traveling path and the deceleration position in the traveling path, based on the designation data.

9. The management system of an unmanned vehicle according to claim 1, further comprising:
an input data acquisition unit, configured to acquire an input data from an input device,
wherein
the traveling path generation unit is configured to generate at least a part of the traveling path, based on the input data.

10. The management system for an unmanned vehicle according to claim 9, wherein
the traveling path generation unit is configured to generate the traveling path at a point of intersection at which the unmanned vehicle travels, based on the input data.

11. The management system of an unmanned vehicle according to claim 1, further comprising:
an outline storage unit, configured to store an outline data indicating an outline of a traveling track where the unmanned vehicle travels,
wherein
the traveling path generation unit is configured to generate at least a part of the traveling path, based on the outline data.

12. The management system of an unmanned vehicle according to claim 1, further comprising:
a speed data storage unit, configured to store an upper limit speed data indicating a relationship between a gradient of a traveling track where the unmanned vehicle travels and an upper limit value of a traveling speed of the unmanned vehicle,
wherein
the speed calculation unit is configured to calculate the target traveling speed, based on the gradient of the traveling track and the upper limit speed data.

13. The management system of an unmanned vehicle according to claim 1, further comprising:
an input data acquisition unit, configured to acquire an input data from an input device,
wherein
the input data includes a correction data to correct the traveling path, and
the management system further includes a travel data transmission unit, configured to transmit a corrected traveling path indicating the traveling path corrected based on the correction data, and a target traveling speed of the unmanned vehicle calculated based on the corrected traveling path, to the unmanned vehicle.

14. A management method for an unmanned vehicle, comprising:
generating a traveling path of an unmanned vehicle;
calculating a target traveling speed of the unmanned vehicle traveling along the traveling path, based on the traveling path; and
detecting a deceleration position indicating a position where the target traveling speed drops in the traveling path.

15. The management method for an unmanned vehicle according to claim 14, wherein
a position where the target traveling speed becomes equal to or lower than a speed threshold is detected as the deceleration position.

16. The management method for an unmanned vehicle according to claim 14, wherein
the traveling path is generated so as to connect a departure position and an arrival position of the unmanned vehicle,
a speed profile indicating a relationship between a distance from the departure position in the traveling path and the target traveling speed is calculated, and
the deceleration position is detected in the speed profile.

17. The management method for an unmanned vehicle according to claim 16, wherein
the unmanned vehicle is an unmanned dump truck traveling between a loading area and a discharging area,
the departure position is defined to be one of the loading area and the discharging area, and
the arrival position is defined to be the other of the loading area and the discharging area.

18. The management method for an unmanned vehicle according to claim 16, further comprising:
outputting the speed profile and the deceleration position in the speed profile.

19. The management method for an unmanned vehicle according to claim 18, wherein
the outputting the deceleration position includes causing a display device to display the speed profile and the deceleration position.

20. The management method for an unmanned vehicle according to claim 19, wherein
the deceleration position is displayed on the display device in a different display form from other positions in the speed profile.
